(19) United States
(12) Patent Application Publication
(10) Pub. No.: US 2026/0035921 A1
(43) Pub. Date: Feb. 5, 2026

(54) ROOFING SHINGLES INCLUDING GRANULES COMPRISING RESIDUAL ASPHALT

(71) Applicant: Owens Corning Intellectual Capital, LLC, Toledo, OH (US)

(72) Inventors: Samuel Ares, Loveland, OH (US); Michele Denise Nielsen, Baltimore, OH (US); William Edwin Smith, Pataskala, OH (US)

(21) Appl. No.: 19/263,863

(22) Filed: Jul. 9, 2025

Related U.S. Application Data
(60) Provisional application No. 63/677,118, filed on Jul. 30, 2024.

(51) Int. Cl. E04D 1/20; C08K 11/00; C08L 95/00; E04D 1/00

(52) U.S. Cl. CPC E04D 1/20; C08K 11/005; C08L 95/00; E04D 2001/005

(57) ABSTRACT

A roofing shingle is provided that includes an asphalt-coated sheet and a plurality of granules disposed on the asphalt-coated sheet. The plurality of granules comprises from 1 wt. % to 7 wt. % of residual asphalt. The granules are at least partially coated with the residual asphalt. The resultant roofing shingle has a granule scrub loss of less than 1.0 g, as measured according to ASTM D4977. The plurality of granules including the residual asphalt may be obtained, for example, from recycled asphalt shingles.

### CROSS-REFERENCE TO RELATED APPLICATIONS

This application claims priority to and all benefit of U.S. Provisional Patent Application No. 63/677,118, filed on Jul. 30, 2024, the entire disclosure of which is fully incorporated herein by reference.

### BACKGROUND

Asphalt-based roofing materials, such as roofing shingles, are installed on the roofs of buildings to provide protection from the elements. Typically, the roofing material includes a substrate, an asphalt coating on the substrate, and a surface layer of granules or other surfacing minerals embedded in the asphalt coating. The granules may be used to impart color to the shingle, and can also provide a functional benefit, such as by providing algae, moss, or fungus resistance, solar reflectivity, weather resistance, ultraviolet (UV) protection, and the like. Minerals, such as sand or other particulates, may be applied to surfaces of roofing material to reduce sticking between adjacent surfaces when the roofing material is stacked in a bundle or a roll.

In general, granules and other surfacing minerals are embedded in the asphalt coating on the substrate by the application of pressure and are retained by adherence to the asphalt. In the case of some shingles, the loss of granules can reduce the life of the roof in addition to compromising the aesthetics of the roofing system.

Accordingly, there is an ongoing need for surfacing minerals that exhibit an increased adherence to the asphalt coating of the shingle.

### SUMMARY

According to a first aspect, a roofing shingle comprises an asphalt-coated sheet and a plurality of granules disposed on at least a portion of the asphalt-coated sheet. The plurality of granules comprises from 1 wt. % to 7 wt. % of residual asphalt based on a total weight of the plurality of granules. The granules are at least partially coated with the residual asphalt. The roofing shingle has a granule scrub loss of less than 1.0 g as measured according to ASTM D4977.

In a second aspect, a roofing shingle includes the shingle of the first aspect, wherein the plurality of granules is disposed on a headlap portion of the asphalt-coated sheet.

In a third aspect, a roofing shingle includes the shingle of the first or second aspects, wherein the granule scrub loss according to ASTM D4977 is improved by greater than or equal to about 5% based on a loss of total mass compared to a loss of total mass of a comparable shingle not including the residual asphalt coating.

In a fourth aspect, a roofing shingle includes the shingle of any preceding aspect, wherein the roofing shingle has a granule scrub loss of less than 0.5 g as measured according to ASTM D4977.

In a fifth aspect, a roofing shingle includes the shingle of any preceding aspect, wherein the plurality of granules comprises from 1 wt. % to 5.5 wt. % of residual asphalt based on a total weight of the plurality of granules.

In a sixth aspect, a roofing shingle includes the shingle of any preceding aspect, wherein the plurality of granules is obtained from recycled asphalt shingles.

In a seventh aspect, a roofing shingle includes the shingle of any preceding aspect, wherein the plurality of granules is a first plurality of granules, the roofing shingle further comprises a second plurality of granules, and the second plurality of granules do not include a residual asphalt coating.

In an eighth aspect, a roofing shingle includes the shingle of any preceding aspect, wherein the asphalt coating comprises non-oxidized asphalt.

In a ninth aspect, a roofing shingle includes the shingle of any preceding aspect, wherein the asphalt coating comprises polymer modified asphalt.

According to a tenth aspect, a method of manufacturing a roofing shingle comprises applying an asphalt coating to at least one surface of a substrate, thereby forming an asphalt-coated sheet, and depositing a plurality of recycled granules on the asphalt-coated sheet. The plurality of recycled granules has residual asphalt at least partially coated thereon, and the plurality of recycled granules were obtained from recycled asphalt shingles. The residual asphalt coating is present in an amount of 1 wt. % to 7 wt. %, based on a total weight of the plurality of recycled granules.

In an eleventh aspect, a method comprises the method of the tenth aspect, wherein the plurality of recycled granules is not subjected to a cleaning step or separation step prior to being deposited on the asphalt-coated sheet.

In a twelfth aspect, a method comprises the method of the tenth or eleventh aspects, further comprising depositing on the asphalt-coated sheet a plurality of virgin granules.

In a thirteenth aspect, a method comprises the method of the twelfth aspect, wherein the plurality of recycled granules and the plurality of virgin granules are blended together and deposited on the asphalt-coated sheet simultaneously.

In a fourteenth aspect, a method comprises the method of any of the tenth through thirteenth aspects, wherein the roofing shingle has a granule scrub loss of less than 1.0 g as measured according to ASTM D4977.

In a fifteenth aspect, a method comprises the method of any of the tenth through fourteenth aspects, wherein the roofing shingle has a granule scrub loss of less than 0.5 g as measured according to ASTM D4977.

In a sixteenth aspect, a method comprises the method of any of the tenth through fifteenth aspects, wherein the granule scrub loss according to ASTM D4977 is improved by greater than or equal to about 5% based on a loss of total mass compared to a loss of total mass of a comparable shingle not including the residual asphalt coating.

In a seventeenth aspect, a method comprises the method of any of the tenth through sixteenth aspects, wherein the plurality of recycled granules comprises from 1 wt. % to 5.5 wt. % of residual asphalt based on a total weight of the plurality of recycled granules.

In an eighteenth aspect, a method comprises the method of any of the tenth through seventeenth aspects, wherein the asphalt coating comprises non-oxidized asphalt.

In a nineteenth aspect, a method comprises the method of any of the tenth through eighteenth aspects, wherein the asphalt coating comprises polymer modified asphalt.

In a twentieth aspect, a method comprises the method of any of the tenth through nineteenth aspects, wherein the plurality of recycled granules is deposited on a headlap portion of the roofing shingle.

In a twenty-first aspect, a roofing product comprises: an asphalt-coated sheet; and a plurality of surfacing minerals disposed on at least a portion of the asphalt-coated sheet. The plurality of surfacing minerals comprises from 1 wt. % to 7 wt. % of residual asphalt based on a total weight of the plurality of surfacing minerals, and the surfacing minerals are at least partially coated with the residual asphalt. The roofing product has a surfacing mineral scrub loss of less than 1.0 g as measured according to ASTM D4977.

In a twenty-second aspect, a roofing product comprises the roofing product of the twenty-first aspect, wherein the surfacing mineral scrub loss according to ASTM D4977 is improved by greater than or equal to about 5% based on a loss of total mass compared to a loss of total mass of a comparable roofing product not including the residual asphalt coating.

In a twenty-third aspect, a roofing product comprises the roofing product of the twenty-first or twenty-second aspects, wherein the roofing product has a surfacing mineral scrub loss of less than 0.5 g as measured according to ASTM D4977.

In a twenty-fourth aspect, a roofing product comprises the roofing product of any of the twenty-first through twenty-third aspects, wherein the plurality of surfacing minerals comprises from 1 wt. % to 5.5 wt. % of residual asphalt based on a total weight of the plurality of surfacing minerals.

In a twenty-fifth aspect, a roofing product comprises the roofing product of any of the twenty-first through twenty-fourth aspects, wherein the plurality of surfacing minerals are obtained from recycled asphalt shingles.

In a twenty-sixth aspect, a roofing product comprises the roofing product of any of the twenty-first through twenty-fifth aspects, wherein the asphalt coating comprises non-oxidized asphalt.

In a twenty-seventh aspect, a roofing product comprises the roofing product of any of the twenty-first through twenty-sixth aspects, wherein the asphalt coating comprises polymer modified asphalt.

In a twenty-eighth aspect, a roofing product comprises the roofing product of any of the twenty-first through twenty-seventh aspects, wherein the bond strength between adjacent layers of the roofing product according to a modified ASTM D6381M-15 (2020) is improved by greater than or equal to about 10% compared to a comparable roofing product not including the residual asphalt coating.

In a twenty-ninth aspect, a roofing product comprises the roofing product of any of the twenty-first through twenty-eighth aspects, wherein the plurality of surfacing minerals comprises sand.

### BRIEF DESCRIPTION OF THE DRAWINGS

Exemplary aspects of the disclosure will be apparent from the more particular description of certain aspects provided below and as illustrated in the accompanying drawings, in which:

FIG. 1 is a schematic elevational view of an apparatus for manufacturing shingles according to various aspects disclosed herein; and

FIG. 2 is a perspective view of an example laminated shingle formed on the apparatus of FIG. 1 and including granules according to various aspects disclosed herein.

### DETAILED DESCRIPTION

The present invention will now be described with occasional reference to the illustrated aspects of the invention. This invention may, however, be embodied in different forms and should not be construed as limited to the aspects set forth herein, nor in any order of preference. Rather, these aspects are provided so that this disclosure will be more thorough, and will convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular aspects only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in various aspects of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

As used in the description of the invention and the appended claims, the term “longitudinal” or “longitudinally” is defined as substantially parallel with the machine direction.

The term “surfacing minerals,” as used herein, refers to roofing granules, sand, flakes, or other particulates suitable for application to one or more surfaces of a roofing product.

Composite shingles, such as asphalt shingles, are a commonly used roofing product. One example of a composite shingle is disclosed in U.S. Pat. No. RE46,177, which is incorporated herein by reference in its entirety. Asphalt shingle production generally includes feeding a base material from an upstream roll and coating it first with an asphalt material, then a layer of granules. The base material is typically made from a fiberglass mat provided in a continuous shingle membrane or sheet. It should be understood that the base material may be any suitable support material.

Composite shingles may have a headlap region and a prime region. The headlap region may be ultimately covered by adjacent shingles when installed upon a roof. The prime region will be ultimately visible when the shingles are installed upon a roof.

Various types of surfacing minerals may be applied to an asphalt-coated base material, such as granules, sand, backdust, and other particulates. The granules deposited on the asphalt-coated base material shield the asphalt material from direct sunlight, offer resistance to fire, and provide texture and color to the shingle, among other benefits. The granules generally involve at least two different types of granules. Headlap granules are applied to the headlap region. Headlap granules are relatively low in cost and primarily serve the functional purposes of covering the underlying asphalt material for a consistent shingle construction, balancing sheet weight, and preventing overlapping shingles from sticking to one another. In various aspects, a plurality of granules comprising residual asphalt may be applied as headlap granules. Colored granules or other prime granules are relatively expensive and are applied to the shingle at the prime regions. Prime granules are disposed upon the asphalt strip for both the functional purpose of protecting the underlying asphalt strip and for providing an aesthetically pleasing appearance of the roof.

It has been surprisingly discovered that when at least a portion of the surfacing minerals on a roofing shingle comprise residual asphalt, the surfacing minerals as a whole exhibit improved adhesion to an asphalt coating on a shingle. “Residual asphalt,” as used herein, refers to the presence of asphalt at least partially coating a surfacing mineral or collection of surfacing minerals. In particular, the roofing shingles disclosed herein comprise a plurality of surfacing minerals comprising from about 1 wt. % to about 10 wt. % or from about 1 wt. % to about 7 wt. % of residual asphalt, based on a total weight of the plurality of surfacing mineral. In various aspects, the plurality of surfacing minerals exhibit improved adhesion to an asphalt coating of a shingle as a result of the residual asphalt coating on the plurality of surfacing minerals as compared to surfacing minerals not including the residual asphalt coating. For example, the plurality of granules exhibit improved adhesion to an asphalt coating of a shingle as a result of the residual asphalt coating on the plurality of granules as compared to granules not including the residual asphalt coating.

At least a portion of the plurality of surfacing minerals may comprise recycled minerals (e.g., recycled granules) that were previously applied to a roofing shingle or otherwise used in a roofing system. For example, the granules may be granules obtained from recycled asphalt shingles (RAS). Accordingly, various aspects disclosed herein may provide a sustainable alternative for recycling or reusing roofing surfacing minerals, which have conventionally been discarded, despite other portions of a roofing shingle being recycled.

Asphalt shingle recycling operations typically grind used asphalt shingles and remove the granules from the resultant material. The removed granules contain at least some residual asphalt from the asphalt coating of the shingle and are usually discarded, while the remaining components of the recycled asphalt shingles are further processed for inclusion into roads and other paving applications. Alternatively, the granules may be subjected to an extensive cleaning process, which may be expensive. Various aspects disclosed herein utilize the granules removed from recycled asphalt shingles, including the residual asphalt coating present on the granules.

Although various aspects of the present disclosure will be described with reference to granules, it should be noted that the aspects disclosed herein are applicable to any surfacing minerals applied to front or back surfaces of various types of roofing materials. By way of example and not limitation, sand or other types of minerals used as backdust or applied on the front or back surfaces of any one of a variety of roofing materials may include a residual asphalt coating.

### Shingle Manufacturing Process

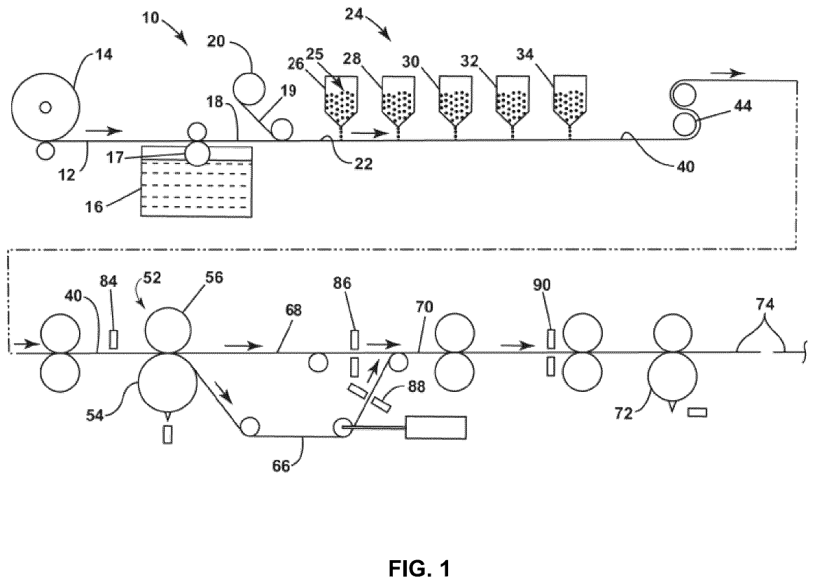

Referring now to the drawings, FIG. 1 illustrates an example apparatus 10 for manufacturing an asphalt-based roofing material according to a manufacturing process wherein a continuous sheet is passed in a machine direction (indicated by the arrows) through a series of manufacturing operations. The sheet can pass at a speed of at least about 200 feet/minute (61 meters/minute), and can pass at a speed within the range of between about 450 feet/minute (137 meters/minute) and about 800 feet/minute (244 meters/minute) or even at or above 1200 feet/minute. The sheet, however, can move at any desired speed.

The manufacturing process continues as the continuous sheet of substrate or shingle mat 12 is payed out from a roll 14. The substrate can be any type known for use in reinforcing asphalt-based roofing materials, such as a non-woven web of glass fibers. The shingle mat 12 is fed through a coater 16 where an asphalt coating is applied to the shingle mat 12. The asphalt coating can be applied in any suitable manner. In one example, the shingle mat 12 contacts a roller 17, which is in contact with a supply of hot, melted asphalt. The roller 17 completely covers the shingle mat 12 with a tacky coating of hot, melted asphalt to define a first asphalt coated sheet 18. Alternatively, the asphalt coating can be sprayed on, rolled on, or applied to the first asphalt coated sheet 18 by any other suitable means.

Next, and optionally, a continuous strip of a reinforcement material or reinforcement tape 19, is payed out from a roll 20. The reinforcement tape 19 adheres to the first asphalt coated sheet 18 to define a second asphalt coated sheet 22. In any of the aspects disclosed herein, the reinforcement tape 19 can be attached to the first asphalt coated sheet 18 by the adhesive mixture of the asphalt in the first asphalt coated sheet 18. Alternatively, the reinforcement tape 19 can be attached to the first asphalt coated sheet 18 by any suitable means, such as other adhesives. In any aspects, the reinforcement tape 19 can be formed from polyester. In other aspects, the reinforcement tape 19 can be formed from polyolefin, such as polypropylene or polyethylene, and can include any polymeric material having the desired properties for the finished product and which endures the manufacturing environment. The reinforcement tape 19 can be formed from any material which preferably reinforces and strengthens the nail zone of a shingle, such as, by way of non-limiting example, paper, film, scrim material, and woven or non-woven fibers, such as glass, natural or polymer fibers. Alternatively, the reinforcement tape 19 can be formed of any material that does not provide such physical properties, but simply provides an indicia of the nail zone.

The second asphalt coated sheet 22 passes beneath a series of granule dispensers 24 for the application of granules to the upper surface of the second asphalt coated sheet 22. The granule dispensers 24 can be of any type suitable for depositing granules 25 onto the asphalt coated sheet. In some aspects, a series of granule dispensers 24 can include one or more color blenders, for example, the series of granule dispensers 24 can include four color blend blenders 26, 28, 30, and 32 and a background blender 34. Any desired number of color blenders, however, can be used. Moreover, the granule dispensers 24 can dispense alternate forms of granules such as granules having a residual asphalt coating, as defined below. Granules can be applied with a separate granule dispenser or can be mixed into any of the four color blend blenders 26, 28, 30, and 32 and/or the background blender 34. Alternatively, granules 25 can be dispensed onto the second asphalt coated sheet 22 by any means suitable for dispensing granules 25. After all the granules 25 are deposited on the second asphalt coated sheet 22 by the series of granule dispensers 24, the second asphalt coated sheet 22 becomes a granule covered sheet 40.

In any of the aspects disclosed herein, a different size of granules may be applied in the nail zone instead of the reinforcement tape. For example, the granules having a residual asphalt coating thereon may be of a different size (e.g., larger) than the granules applied adjacent to the nail zone and may be used to provide a visual differentiation indicative of the nail zone.

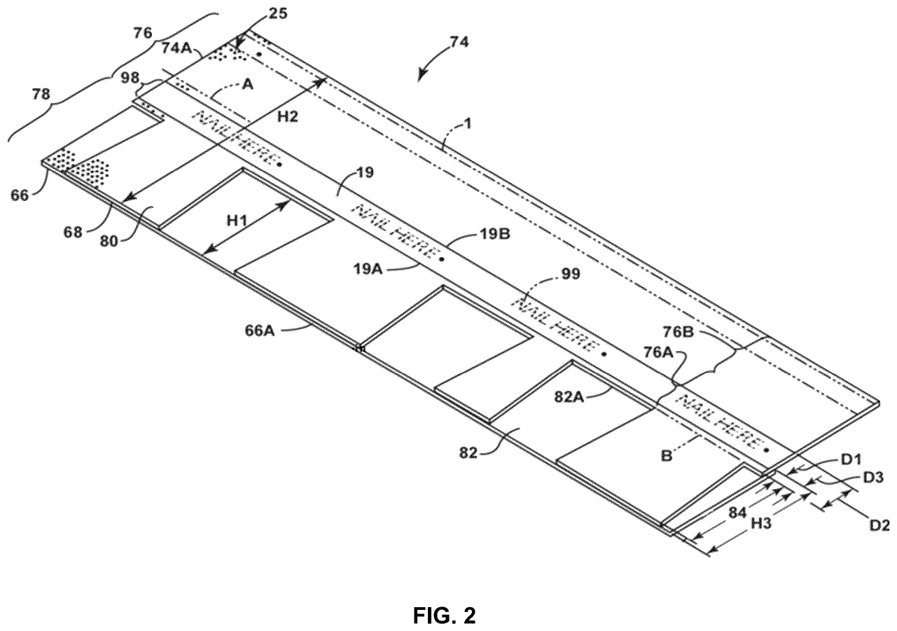

To the extent a reinforcement tape is provided, the reinforcement tape 19 can include an upper surface to which the granules 25 will not substantially adhere. The reinforcement tape 19, alternatively, can include an upper surface to which the granules 25 will adhere. For example, the apparatus 10 can include any desired means for depositing the granules 25 onto substantially the entire second asphalt coated sheet 22, except for the portion of the second asphalt coated sheet 22, covered by the reinforcement tape 19, as best shown in FIG. 2. Alternately, the granules 25 can be deposited onto substantially the entire second asphalt coated sheet 22, including the reinforcement tape 19, where the reinforcement tape 19 includes an upper surface to which the granules 25 substantially will not adhere.

The granule covered sheet 40 is turned around a slate drum 44 to press the granules 25 into the asphalt coating and to temporarily invert the granule covered sheet 40 so that the excess granules will fall off and can be recovered and reused. While the granule covered sheet 40 is inverted, surfacing minerals such as sand may be applied as backdust to the back surface of the sheet. In any of the aspects disclosed herein, the surfacing minerals may include a residual asphalt coating thereon. Next, the granule covered sheet 40 is fed through a rotary pattern cutter 52 having a bladed cutting cylinder 54 and a backup roll 56. Optionally, the pattern cutter 52 can cut a series of cutouts in the tab portion of the granule covered sheet 40, and cut a series of notches in the underlay portion of the granule covered sheet 40.

The pattern cutter 52 can also cut the granule covered sheet 40 into a continuous underlay sheet 66 and a continuous overlay sheet 68. The underlay sheet 66 can be aligned beneath the overlay sheet 68, and the two sheets 66, 68 can be laminated together to form a continuous laminated sheet 70. The continuous underlay sheet 66 can be routed on a longer path than the path of the continuous overlay sheet 68. Further downstream, the continuous laminated sheet 70 is passed into contact with a rotary length cutter 72 that cuts the laminated sheet into individual laminated shingles 74.

In order to facilitate synchronization of the cutting and laminating, various sensors and controls can be employed. For example, sensors, such as photo eyes 86 and 88 can synchronize the continuous underlay sheet 66 with the continuous overlay sheet 68. Sensors 90 can synchronize the notches and cutouts of the continuous laminated sheet 70 with the end cutter or length cutter 72.

Referring now to FIG. 2, an example laminated roofing shingle 74 is illustrated according to aspects described herein. The shingle 74 includes the overlay sheet 68 attached to the underlay sheet 66. The shingle 74 has a first end 74A, a second end 74B, and a longitudinal axis A. The overlay sheet 68 includes a headlap portion 76 and a tab portion 78. The headlap portion 76 includes a lower zone 76A and an upper zone 76B. The tab portion 78 defines a plurality of tabs 80 alternating a plurality of cutouts 82 such that each of the plurality of cutouts 82 can be located between each adjacent tab 80. By way of non-limiting example, the tab portion 78 can include four tabs 80, although any suitable number of tabs 80 can be provided. The headlap portion 76 and the tabs 80 can include one or more granule patterns thereon. In any of the aspects disclosed herein, granules comprising residual asphalt may be applied to the headlap portion 76, although it is contemplated that the granules comprising residual asphalt may be applied to other portions of the shingle, including on the front or back surfaces. In aspects, the granules comprising residual asphalt may be blended with virgin granules (e.g., granules not including residual asphalt).

Each cutout 82 has a first height H1. As illustrated in FIG. 2, each cutout 82 has the same height H1 as another cutout 82. It will be understood, however, that each cutout 82 can have a different height H1 as another cutout 82. A line B, collinear with an upper edge 82A of the cutouts 82, defines an upper limit of an exposed region 84 of the underlay sheet 66.

In aspects, the height of the exposed region 84 is equal to the first height H1, however, the height of the exposed region 84 may be any desired height, and the top of the cutouts 82 need not be collinear as illustrated. In a shingle 74 wherein the cutouts 82 have different first heights H1, the line B can alternatively be collinear with an upper edge 82A of the cutout 82 having the largest height H1.

The reinforcement tape 19 is located longitudinally on the headlap portion 76 from the first end 74A to the second end 74B of the shingle 74 within the lower zone 76A of the headlap portion 76. A lower edge 19A of the reinforcement tape 19 is spaced apart from the line B by a distance D1, and an upper edge 19B of the reinforcement tape 19 is spaced apart from the line B by a distance D2. By way of non-limiting example, the distance D1 is within the range of from about ¼ inch to about ¾ inch. In another example, the distance D1 is about ½ inch. In yet another example, the distance D2 is within the range of from about 1¾ inches to about 2¼ inches. In another example, the distance D2 is about 2 inches. The distances D1 and D2 can, however, be of any other desired length, including zero for D1. For example, in aspects, the reinforcement tape 19 substantially covers the entire headlap portion 76 of the overlay sheet 68. It will be further understood, however, that one or more additional lengths of reinforcement tape 19 can be disposed longitudinally on the headlap portion 76, even outside the nail zone, such as shown by the phantom line 19′. It will be understood that the reinforcement material need not extend from the first end 74A to the second end 74B of the shingle 74, and can be disposed in one or more sections or portions on the shingle 74.

The reinforcement tape 19 can define a nail zone 98 and can optionally include indicia 99. By way of non-limiting example, the indica 99 can be text such as “nail here”, as shown in FIG. 2. It will be understood, however, that any other text or other indicia can included on the reinforcement tape 19. It will also be understood that the reinforcement tape 19 can be provided without such text or indicia. Such indicia 99 on the reinforcement tape 19 ensure that the nail zone 98 may be easily and quickly identified by the shingle installer.

The overlay sheet 68 has a second height H2. The underlay sheet 66 includes a leading edge 66A, a trailing edge 66B, and has a third height H3. The trailing edge 66B of the underlay sheet 66 is spaced apart from the line B by a distance D3. As illustrated, the distance D3 is about ⅜ inch, however, the distance D3 may be any desired distance.

The third height H3 of the underlay sheet 66 is less than one-half the second height H2 of the overlay sheet 68. The overlay sheet 68 and the underlay sheet 66 thereby define a two-layer portion of the laminated shingle 74 and a single-layer portion of the laminated shingle 74, wherein at least a portion of the reinforcement tape 19 is preferably adhered to the single-layer portion of the laminated shingle 74. Alternately, the third height H3 of the underlay sheet 66 may be equal to one-half the second height H2 of the overlay sheet 68, or greater than one-half of the second height H2 of the overlay sheet 68. Such a relationship between the underlay sheet 66 and the overlay sheet 68 allows the reinforcement tape 19 to be positioned such that a reinforced nail zone is provided at a substantially single-layer portion of the shingle 74.

In the exemplary shingle 74 illustrated in FIG. 2, the shingle 74 has a nail pull-through value, preferably measured in accordance with a desired standard, such as prescribed by ASTM test standard D3462. For example, the shingle 74 may have a nail pull-through value that is greater than in an otherwise identical shingle having no such reinforcement tape 19. The shingle 74 can have a nail pull-through value within—the range of from about ten percent to about 100 percent greater than in an otherwise identical shingle having no such reinforcement tape 19. Alternatively, the shingle 74 can have a nail pull-through value about 50 percent greater than in an otherwise identical shingle having no such reinforcement tape 19.

The granules 25 applied to the upper surface of the second asphalt coated sheet 22 can include any granule type known in the art, including mineral, non-mineral, and polymeric granules, conventional granules, and the granules including residual asphalt disclosed herein.

### Surfacing Minerals Including Residual Asphalt

As set forth above, the residual asphalt coating may be applied to a plurality of surfacing minerals, such as granules, sand, or other minerals. The plurality of surfacing minerals may include from about 1 wt. % to about 10 wt. % residual asphalt or from about 1 wt. % to about 7 wt. % residual asphalt, based on a total weight of the plurality of surfacing minerals. For example, the plurality of surfacing minerals may include from about 1 wt. % to about 10 wt. %, from about 1 wt. % to about 9 wt. %, from about 1 wt. % to about 8 wt. %, from about 1 wt. % to about 7 wt. %, from about 2 wt. % to about 7 wt. %, from about 3 wt. % to about 7 wt. %, from about 4 wt. % to about 7 wt. %, from about 5 wt. % to about 7 wt. %, from about 1 wt. % to about 6 wt. %, from about 2 wt. % to about 6 wt. %, from about 3 wt. % to about 6 wt. %, from about 4 wt. % to about 6 wt. %, from about 5 wt. % to about 6 wt. %, from about 1 wt. % to about 5 wt. %, from about 1 wt. % to about 5.5 wt. %, from about 2 wt. % to about 5.5 wt. %, from about 3 wt. % to about 5.5 wt. %, from about 4 wt. % to about 5.5 wt. %, from about 5 wt. % to about 5.5 wt. %, from about 1 wt. % to about 5 wt. %, from about 2 wt. % to about 5 wt. %, from about 3 wt. % to about 5 wt. %, from about 4 wt. % to about 5 wt. %, from about 1 wt. % to about 4 wt. %, from about 2 wt. % to about 4 wt. %, from about 3 wt. % to about 4 wt. %, from about 1 wt. % to about 3 wt. %, or from about 2 wt. % to about 3 wt. % of the residual asphalt, including any and all ranges and subranges including any of these endpoints.

In aspects of the disclosure in which the surfacing minerals are granules, the plurality of granules may include from about 1 wt. % to about 10 wt. % or from about 1 wt. % to about 7 wt. % residual asphalt, based on a total weight of the plurality of granules. For example, the plurality of granules may include from about 1 wt. % to about 7 wt. %, from about 2 wt. % to about 7 wt. %, from about 3 wt. % to about 7 wt. %, from about 4 wt. % to about 7 wt. %, from about 5 wt. % to about 7 wt. %, from about 1 wt. % to about 6 wt. %, from about 2 wt. % to about 6 wt. %, from about 3 wt. % to about 6 wt. %, from about 4 wt. % to about 6 wt. %, from about 5 wt. % to about 6 wt. %, from about 1 wt. % to about 5 wt. %, from about 1 wt. % to about 5.5 wt. %, from about 2 wt. % to about 5.5 wt. %, from about 3 wt. % to about 5.5 wt. %, from about 4 wt. % to about 5.5 wt. %, from about 5 wt. % to about 5.5 wt. %, from about 1 wt. % to about 5 wt. %, from about 2 wt. % to about 5 wt. %, from about 3 wt. % to about 5 wt. %, from about 4 wt. % to about 5 wt. %, from about 1 wt. % to about 4 wt. %, from about 2 wt. % to about 4 wt. %, from about 3 wt. % to about 4 wt. %, from about 1 wt. % to about 3 wt. %, or from about 2 wt. % to about 3 wt. % of the residual asphalt, including any and all ranges and subranges including any of these endpoints.

Although the amount of residual asphalt present on the plurality of surfacing minerals may vary, it is generally believed that at least about 1 wt. % of residual asphalt is needed to provide the improved surfacing mineral adhesion. Moreover, the use of an amount of residual asphalt of greater than about 10 wt. % or greater than 7 wt. % can render the surfacing minerals difficult to process and can create issues during the manufacture of the roofing material. The particular amount of residual asphalt suitable for use can vary depending on, for example the time and temperature of the manufacturing process. For example, higher temperatures and longer processing times may further limit the amount of residual asphalt suitable for use.

The residual asphalt is not particularly limited in type. In any of the aspects disclosed herein, the residual asphalt may be an oxidized asphalt, a polymer modified asphalt (PMA), or other type of asphalt used in the preparation of roofing shingles. However, in aspects, the residual asphalt may have one or more properties that differ from the coating asphalt applied to the substrate of the shingle as a result of the weathering and aging of the surfacing minerals in use.

As used herein the term “asphalt” is meant to include asphalts produced from petroleum refining, including residua from atmospheric distillation, from vacuum distillation, and from solvent de-asphalting units, recycled asphalt streams, such as re-refined motor oil bottoms. Mixtures of different asphalts can also be used. The aspects disclosed herein can also be used with natural bitumen, such as the products extracted from the oil sands in Alberta or asphalts derived from oil sands by various refinery processes.

By “roofing shingle coating asphalt,” “asphalt material,” or “coating asphalt,” as used herein, is meant an asphalt that is suitable for use as a coating asphalt to make asphalt roofing shingles as defined by ASTM D 3462-16: a softening point minimum of from 190° F. (88° C.) to 320° F. (160° C.) and a penetration at 77° F. (25° C.) minimum of 15 decimillitres (dmm). This softening point is referred to herein as the “target softening point”. Asphalts falling under the ASTM D 3462-16 definition of coating asphalt are unfilled asphalts, prior to any inclusion of filler materials.

In other aspects, the term “coating asphalt” meets one or more of the tighter specifications that may be used by shingle manufacturers. Some examples of these specifications include a softening point of from 200° F. (93° C.) to 215° F. (102° C.), a penetration at 77° F. (25° C.) of from 16 dmm to 22 dmm, a melt viscosity at 400° F. (204° C.) of from 150 centipoise (cps) to 450 cps, a durability of greater than 60 cycles in the Weatherometer, and a flashpoint of greater than 550° F. (288° C.). Other examples of suitable coating asphalts include those with a softening point of from 212° F. (100° C.) to 220° F. (104° C.), a penetration at 77° F. (25° C.) of from 16 dmm to 20 dmm, a melt viscosity at 400° F. (204° C.) of from 275 cps to 375 cps, and a flashpoint of greater than 550° F. (288° C.). In some manufacturers' specifications, a minimum specific target penetration of 15 dmm or 17 dmm is used, although there are a range of different manufacturer specifications.

In various aspects, the plurality of granules may include polymer-based granules formed from an extruded polymer carrier. Generally, the polymer carrier functions to bind the pellets together. The polymer carrier can include homopolymers or copolymers that are linear or branched. The polymer carrier may further include biodegradable polymers or copolymers, bio-sourced polymers, and/or recycled polymers. Copolymers can be random, alternating, or block. Examples of polymeric compounds suitable for use as the polymer carrier include acrylic copolymers, polyesters, polyamides, epoxies, nonacid-containing polyolefins, polyolefin alloys, polypropylene, acid-containing polyolefins, polyvinyl chloride, polyester block amide, ethylene-chlorotrifluoroethylene, nylons, polyvinylidene fluoride, polycarbonates, polyanhydrides, poly(ortho esters), polyphosphoesters, and combinations thereof. In any of the aspects herein, the polymer carrier can include a thermoplastic or thermoset polymeric material. In aspects, the polymeric carrier is selected from high density, low density, and linear low density polyethylene, polypropylene, low and high impact polystyrene, PVS, ABS, polyamides, polyesters, polycarbonate, polyvinyl chloride, polymethyl methacrylate, polyglycolic acid, polyhydroxy butyrate, polyurethanes, polyureas, epoxy, polydimethylsiloxane (PDMS), poly(styrene-butadiene-styrene) (SBS), styrene butadiene rubber (SBR), styrene-(ethylene/butylene)-crystalline block copolymer (SEBS), and acrylic.

Alternatively, in aspects, the plurality of granules may be mineral-based granules. For example, the plurality of granules may include nepheline syenite, quartz, sand, basalt, andesite, diabase, or any other suitable mineral or material conventionally used in roofing granule applications. In aspects, the minerals may be crushed and blended with a binding agent to form the granule.

The granules may further include functional mineral fillers and/or functional pigments. By way of non-limiting example, the functional mineral filler can be limestone, dolomite, fly ash, talc, calcium carbonate, kaolin, wollastonite, glass, nanofillers, silica, barium sulfate, zinc oxide, titanium dioxide, aluminum hydroxide, fumed silica, carbon black, magnesium hydroxide, diatomaceous earth, perlite, ball clay, iron oxide, and combinations or mixtures thereof. Functional pigments can be any pigment capable of imparting a desired property to the granules, such as imparting solar reflectivity, color, UV protection, and the like. Other additives may also be included in the granules.

Although various examples of suitable surfacing minerals have been described, it should be appreciated that, in any of the aspects disclosed herein, the plurality of surfacing minerals can be any type of roofing surfacing mineral that is conventionally made and used in roofing applications. Accordingly, in aspects herein, the surfacing mineral itself is not particularly limiting and may be any available recycled surfacing minerals from recycled asphalt shingles, provided that the surfacing minerals include residual asphalt. Moreover, in any of the aspects described herein, the plurality of surfacing minerals may have one or more additional coatings at least partially coating the surfacing minerals. For example, the surfacing minerals may include a ceramic coating beneath the residual asphalt coating.

It should be appreciated that, in any of the aspects disclosed herein, the plurality of surfacing minerals having the residual asphalt coating may be blended with virgin, or new, surfacing minerals that do not include a residual asphalt coating. For example, as described above, the plurality of granules having the residual asphalt coating may be blended with new granules before or during application to the asphalt coating on the substrate through the use of granule dispensers. The new granules may be similar to the plurality of granules having the residual asphalt coating (e.g., both may be polymer-based granules or mineral granules), or a different type of granule. When blended with new surfacing minerals, the plurality of surfacing minerals having a residual asphalt coating may be present in any amount in the blend, such as from about 5 wt. % to about 95 wt. % of the total weight of the granule blend. Other amounts of surfacing minerals having a residual asphalt coating in the blend are contemplated and possible, and may vary depending on the amount of residual asphalt on the surfacing minerals, processing times and temperatures, and the asphalt coating on the shingle substrate.

### Shingle

As described above, the granules are applied to the roofing shingle by disposing the granules on at least a portion of an asphalt-coated sheet. The asphalt-coated sheet is formed by application of a coating asphalt to a substrate of the roofing shingle. The substrate may be any type known for use in reinforcing asphalt-based roofing materials, such as a nonwoven web of glass fibers. Alternatively, the substrate may be a scrim or felt of fibrous materials such as mineral fibers, cellulose fibers, rag fibers, mixtures of mineral and synthetic fibers, or the like.

In any of the aspects disclosed herein, the coating asphalt can be, for example, an oxidized asphalt, a partially-oxidized asphalt, or a polymer modified asphalt composition. As used herein, a “polymer modified asphalt” is an asphalt-based composition which comprises an asphalt material that is modified with one or more polymers. In some aspects, the coating composition further comprises a secondary additive that is a wax, fatty acid amide, or other viscosity reducing material.

The asphalt material may include various types or grades of asphalt, including flux, paving grade asphalt blends, propane washed asphalt, and/or blends thereof. Effective blends of asphalt or bituminous materials are understood by those of ordinary skill in the art. In aspects, the asphalt includes one or more fillers, such as a filler of finely ground inorganic particulate matter, such as ground limestone, dolomite or silica, talc, sand, cellulosic materials, fiberglass, calcium carbonate, or combinations thereof. The one or more fillers can be included in at least 10 wt. %, based on the total weight of the polymer modified asphalt composition. For example, the one or more fillers can be included in about 20 wt. % to about 80 wt. %, including about 25 wt. % to about 75 wt. %, about 30 wt. % to about 70 wt. % and about 40 to about 65 wt. %, based on the total weight of the polymer modified asphalt composition. In any of the aspects disclosed herein, the asphalt composition further comprises various oils, fire retardant materials, and other compounds conventionally added to asphalt compositions for roofing applications.

The asphalt material has the advantage of being prepared using a wide array of paving grade asphalt materials, such as different types of paving asphalts used independently or as a mixture with various types of asphalt, such as, for example, solvent extracted asphalt, naturally occurring asphalt, synthetic asphalt, and recycled asphalt. Typical paving grade asphalts are straight run asphalts derived from the atmospheric and vacuum distillation of crude oils, or are made by blending vacuum tower residua with residua from solvent de-asphalting units or re-refined motor oil bottoms or other recycled streams.

By “paving grade asphalt,” as used herein, is meant a performance grade asphalt according to AASH20 17320-17 that has a softening point within the range of about 60° F. to about 130° F. and a penetration value of at least about 25 dmm. Paving grade asphalts are not typically used in roofing applications because such asphalts are not able to achieve the properties required to be considered “coating grade” asphalt, as defined by ASTM D 3462-16: a softening point minimum of from 190° F. (88° C.) to 235° F. (113° C.) and a penetration at 77° F. (25° C.) minimum of 15 decimillimeter (dmm).

In aspects, the asphalt material used in the asphalt-coated sheet includes at least a paving-grade asphalt. Any suitable paving-grade asphalt(s) can be used, for example paving asphalts which meet the PG 64-22 specifications (AASHTO M320 or AASHTO M332). PG 64-22 is the most common paving specification in the United States. Paving asphalts were previously graded by viscosity and a common asphalt that is similar to the PG 64-22 grade asphalt and also usable in this method, is the old AC20 grade asphalt (ASTM D 3381). Other examples of suitable paving-grade asphalts include PG 67-22, PG 70-22, PG 58-22, PG 58-28, PG 58-22, PG 70-16, PG 70-10, PG 67-10, pen grade 40/50, pen grade 60/70, pen grade 85/100, pen grade 120/150, AR4000, AR8000, and AC/30 grade.

When used, the paving grade asphalt can be included in an amount from about 15 to about 80 wt. %, including about 17 wt. % to about 50 wt. %, including about 20 wt. % to about 45 wt. %, about 22 wt. % to about 40 wt. % and about 24 to about 35 wt. %, based on the total weight of the polymer modified asphalt composition.

In various aspects, one or more additives are added to the paving-grade asphalt, including one or more polymer additive and, optionally, a secondary additive. The polymer additive(s) may include any suitable polymer, or any suitable mixtures of different polymers. In some aspects, the polymer additive comprises an elastomeric radial or linear polymer. The polymer additive may comprise a copolymer such as a linear or radial copolymer. For example, the polymer additive can be one or more of atactic polypropylene (APP), isotactic polypropylene (IPP), styrene-butadiene block copolymer (SBS), chloroprene rubber (CR), amorphous polyolefin, SBR latex, natural and reclaimed rubbers, butadiene rubber (BR), acrylonitrile-butadiene rubber (NBR), isoprene rubber (IR), styrene-polyisoprene (SI), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), hydrogenated SBS, and vinylacetate/polyethylene (EVA). In other aspects, the polymer additive comprises a radial polymer or a combination of linear and radial polymers. Examples of polymer modifiers are also disclosed in U.S. Pat. No. 4,738,884 to Algrim et al. and U.S. Pat. No. 3,770,559, to Jackson, the contents of which are incorporated herein by reference in their entirety.

When used, the polymer additive is included in the polymer modified asphalt coating composition in an amount from about 0.5 wt. % to about 20.0 wt. %, based on the total weight of the polymer modified asphalt coating composition. For example, the polymer additive may be included in an amount from about 1.0 to about 15.0 wt. %, or from about 1.5 to about 10.0 wt. %, or from about 2.0 to about 7.0 wt. %, or from about 2.5 to about 6.8 wt. %, or from about or from about 3.0 to about 6.5 wt. %, or from about 3.5 to about 6.2 wt. %, or from about 5.5 to about 6.15 wt. %, based on the total weight of the polymer modified asphalt coating composition.

In some aspects, the secondary additive is a viscosity reducing agent, such as one or more of a wax, a fatty acid ester, a fatty acid ester salt, and/or a fatty acid amide. The paving-grade asphalt material may be heated and mixed so that the polymer and homogenously blend together. The polymer and the secondary additive do not react or crosslink, and simply form a polymer/secondary additive blend. Accordingly, after blending the polymer modifier and secondary additive into the asphalt, the asphalt composition achieves penetration and softening point values that meet the target ranges for these values in a coating-grade asphalt.

In some aspects, the secondary additive is included in the polymer modified asphalt coating composition in an amount from about 0.01 wt. % to about 20.0 wt. %, based on the total weight of the polymer modified asphalt coating composition. For example, the secondary additive may be included in an amount from about 0.5 wt. % to about 15.0 wt. %, from about 1.0 wt. % to about 10.0 wt. %, from about 1.2 wt. % to about 7.0 wt. %, from about 1.5 wt. % to about 5.0 wt. %, from about 1.6 wt. % to about 3.0 wt. %, from about 1.7 wt. % to about 2.5 wt. %, from about 1.75 wt. % to about 2.4 wt. %, from about 1.8 wt. % to about 2.3 wt. %, from about 1.85 wt. % to about 2.2 wt. %, from about 1.90 wt. % to about 2.15 wt. %, from about 1.95 wt. % to about 2.10 wt. %, or from about 1.98 wt. % to about 2.05 wt. %, based on the total weight of the polymer modified asphalt coating composition. In some aspects, the secondary additive is included in the polymer modified asphalt coating composition in an amount of about 2.0 wt. %, based on the total weight of the polymer modified asphalt coating composition.

Although various aspects are described with reference to roofing shingles, any of the aspects may be applied to other roofing materials, including granulated underlayments, granulated cap sheets, and granulated roll roofing.

### Properties

The use of surfacing minerals including a residual asphalt coating may be effective to improve surfacing mineral adhesion in the resulting roofing shingle. For example, granule adhesion may be determined by following the testing methods in ASTM D4977, which is incorporated herein by reference. ASTM D4977 is a dry “as is” scrub test method for the determination of granule adhesion for granule-surfaced roofing under conditions of abrasion. The test method applies to “as manufactured” material without weathering exposure. Testing for granule adhesion may be performed by abrading the granule-coated surface of a specimen of roofing material for 50 cycles with a wire brush. The mass of the specimen of roofing material prior to abrasion is compared to the mass of the specimen of roofing material after abrasion to determine the loss in mass, which may also be referred to as scrub loss.

In various aspects in which a plurality of granules on the roofing shingle includes a residual asphalt coating, the shingle has a granule scrub loss of less than 1.0 g as measured according to ASTM D4977. For examples, the shingle may have a granule scrub loss of less than 1.0 g, less than 0.75 g, less than 0.60 g, less than 0.50 g, less than 0.40 g, less than 0.35 g, less than 0.30 g, less than 0.25 g, less than 0.24 g, or less than 0.23 g, when tested in accordance with ASTM D4977. In some aspects, the shingle has a scrub loss of from 0.05 g to 1.0 g, from 0.10 g to 0.60 g, from 0.15 g to 0.50 g, from 0.15 g to 0.40 g, or from 0.15 g to 0.30 g, when tested in accordance with ASTM D4977, including any and all ranges and subranges therein.

Where granules including a residual asphalt coating are applied to a shingle, the scrub loss may be compared to the scrub loss of a comparable shingle that is identical with the exception that the granules do not include a residual asphalt coating prior to being applied to the shingle. In aspects, where granules including a residual asphalt coating are applied to a shingle, the shingle has a scrub loss according to ASTM D4977 that is less than 80%, less than 70%, less than 60%, less than 50%, or less than 40% of the scrub loss of a comparable shingle. In some aspects, where granules including a residual asphalt coating (in amounts and quality as described herein) are applied to a shingle, the shingle has a scrub loss according to ASTM D4977 that is improved by greater than or equal to about 5%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than about 50%, greater than about 55%, or greater than about 60%, including any and all ranges and subranges therein, based on the lost mass as compared to the lost mass of a comparable shingle. For example, in some aspects, the scrub loss according to ASTM D4977 can be improved from about 5% to about 60%, from about 10% to about 50%, or from about 15% to about 40%. In some aspects, similar tests can be conducted for other types of surfacing minerals.

In various aspects in which a plurality of surfacing minerals on the roofing shingle includes a residual asphalt coating, the shingle may exhibit an increased bond strength between two shingles of greater than or equal to about 10%, compared to otherwise comparable shingles that do not include surfacing materials comprising residual asphalt coating. Bond strength between two shingles may be determined per a modified ASTM D6381M-15 (2020). Per the modified testing, five test samples are pulled using a pull rate of 12 inches per minute. A sample may be prepared by cutting a 3.75 inches×7 inches coupon aligned from the bottom edge of the shingle, such that the bottom of the coupon is centered around the sealant bead, and a 3.75 inches×9 inches coupon aligned from the top edge of the shingle. The smaller coupon is placed on the face of the larger coupon, such that the sealant is aligned with the paint indicating the nail line or reinforcement strip. The coupon is placed in an oven at 140° F.+/−2° F. for 5 hours in order to allow the sealant to adhere to the substrate, and then allowed to rest at 73° F. for at least one hour to condition to room temperature. The coupon is then placed into a bond fixture such that both ends of the bottom coupons are fixed with clamps, and the Instron clamp is attached to the sealant end of the top coupon. The clamp is pulled at a speed of 12 inches per minute until the adhesive fails, and the peak force is noted.

For example, shingles including surfacing minerals having a residual asphalt may lead to an average bond strength increase of greater than or equal to about 10%, greater than or equal to about 12%, greater than or equal to about 15%, greater than or equal to about 17%, greater than or equal to about 20%, greater than or equal to about 22%, greater than or equal to about 25%, greater than or equal to about 27%, or greater than or equal to about 30% as compared to shingles that are otherwise identical but do not include the residual asphalt coating on the surfacing minerals.

Although various aspects disclosed herein are discussed with reference to granules having a residual asphalt coating thereon as applied to a headlap region of a shingle, it is contemplated that any of the aspects disclosed herein can be employed with the use of minerals of any of a variety of sizes having the residual asphalt coating being applied to exposed surfaces of any type of roofing material, including but not limited to granulated underlayments, granulated cap sheets, and granulated roll roofing, in order to increase the bond strength of the resulting material. For example, minerals (e.g., sand) including a residual asphalt coating can be applied to front or back surfaces of a shingle or other roofing material at a sandlap or nailing zone to increase the bond strength of the mineral to the roofing material or to increase the bond strength between the roofing material to an adjacent surface (e.g., lamination strength).

All combinations of method or process steps as used herein can be performed in any order, unless otherwise specified or clearly implied to the contrary by the context in which the referenced combination is made.

While various inventive aspects, concepts and features of the inventions may be described and illustrated herein as embodied in combination in the aspects disclosed herein, these various aspects, concepts and features may be used in many alternative aspects, either individually or in various combinations and sub-combinations thereof. Unless expressly excluded herein all such combinations and sub-combinations are intended to be within the scope of the present inventions.

### EXAMPLES

The following examples are included for purposes of illustration and are not intended to limit the scope of the methods described herein.

### Example 1

Shingles were prepared using conventional headlap granules (Comparative Sample A) or headlap granules extracted from recycled asphalt shingles (Samples 1 and 2). Sample 2 included granules that were processed through a partial cleaning step and included a relatively high amount of residual asphalt, while Sample 1 included granules that were processed through a more thorough cleaning process and included a relatively low amount of residual asphalt. For both Samples 1 and 2, 80-100% of the granules applied in the headlap portion were the granules extracted from recycled asphalt shingles.

For each of the samples, scrub loss was measured as is. A total of 30 repetitions for each sample was tested, and the results were averaged. The results are provided in Table 1 below.

TABLE 1

| | Comparative | | |
|---|---|---|---|
| | Sample A | Sample 1 | Sample 2 |
| Scrub Loss: Ave. AS IS | 0.64 | 0.43 | 0.26 |
| Residual Asphalt | 0% | 2.89% | 6.87% |

As shown in Table 1, both Sample 1 and Sample 2, which included headlap granules having a residual asphalt coating exhibited an improved (e.g., decreased) scrub loss as compared to Comparative Sample A, which included virgin headlap granules (e.g., granules without a residual asphalt coating). Samples 1 and 2 exhibited an average scrub loss of less than 1 g for as is demonstrating the improvement in granule adhesion as a result of the use of reclaimed granules. Moreover, Samples 1 and 2 exhibited a scrub loss of less than 0.5 g for the as is condition.

### Example 2

Next, shingles were prepared using conventional headlap granules (Comparative Sample B) or headlap granules extracted from recycled asphalt shingles (Sample 3). Sample 3 included granules that were processed through a partial cleaning step. For Sample 3, 100% of the granules applied in the headlap portion were the granules extracted from recycled asphalt shingles.

For each of the samples, scrub loss was measured as is. A total of 30 repetitions for each sample was tested, and the results were averaged. The results are provided in Table 2 below.

TABLE 2

| | Comparative Sample B | Sample 3 |
|---|---|---|
| Scrub Loss: Ave. AS IS | 0.74 | 0.19 |
| Residual Asphalt | 0% | 5.45% |

As shown in Table 2, Sample 3, which included headlap granules having a residual asphalt coating exhibited an improved (e.g., decreased) scrub loss as compared to Comparative Sample B, which included virgin headlap granules (e.g., granules without a residual asphalt coating). Sample 3 exhibited an average scrub loss of less than 0.25 g for as is demonstrating the improvement in granule adhesion as a result of the use of reclaimed granules.

### Example 3

Next, the impact of granules having a residual asphalt coating on the bond strength of the shingle was explored by comparing the bond strength of shingles including conventional headlap granules (Comparative Sample C) or headlap granules extracted from recycled asphalt shingles (Sample 4).

Bond strength between two shingles may be determined per a modified ASTM D6381M-15 (2020). Per the modified testing, five test samples are pulled using a pull rate of 12 inches per minute. A sample may be prepared by cutting a 3.75 inches×7 inches coupon aligned from the bottom edge of the shingle, such that the bottom of the coupon is centered around the sealant bead, and a 3.75 inches×9 inches coupon aligned from the top edge of the shingle. The smaller coupon is placed on the face of the larger coupon, such that the sealant is aligned with the paint indicating the nail line or reinforcement strip. The coupon is placed in an oven at 140° F.+/−2° F. for 5 hours in order to allow the sealant to adhere to the substrate, and then allowed to rest at 73° F. for at least one hour to condition to room temperature. The coupon is then placed into a bond fixture such that both ends of the bottom coupons are fixed with clamps, and the Instron clamp is attached to the sealant end of the top coupon. The clamp is pulled at a speed of 12 inches per minute until the adhesive fails, and the peak force is noted. The averages of the test samples for Comparative Sample C and Sample 4 are reported in Table 3.

TABLE 3

| | Average of Bond 140 F.-73 F. (lbf) |
|---|---|
| Comparative Sample C | 13.94 |
| Sample 4 | 15.42 |

As shown in Table 3, the use of the granules having a residual asphalt coating led to an average bond strength increase of at least 10%. This supports the findings of the other experiments, which indicated that the residual asphalt on the granules improves the bonding between the granules and the asphalt coating on the shingle.

### Example 4

To identify a workable range of residual asphalt coating on the granules, granules coated with a variable amount of residual asphalt coating were placed on a metallic plate and flattened. Then, a 2.3 lb weight was placed on top, followed by the placement of two 4.95 lb weights on the top plate. The set up was then placed in the oven at 145° F. for 1 hour and 50 minutes. Then, the granules stuck to the plate were weighed. The results are reported in Table 4.

TABLE 4

| Residual Asphalt (%) | Granules stuck to plate (g) |
|---|---|
| 0 | −0.02 |
| 1.51 | 2.28 |
| 9.87 | 9.48 |

As expected, the results indicated that an increasing amount of residual asphalt on the granules resulted in increased sticking of the granules to the metallic surface. Accordingly, an increased amount of residual asphalt coating on the granules was determined to be likely to lead to an increased amount of sticking of the granules to metallic surfaces during the process of manufacturing of the shingles.

While various inventive aspects, concepts and features of the inventions may be described and illustrated herein as embodied in combination in the aspects disclosed herein, these various aspects, concepts and features may be used in many alternative aspects, either individually or in various combinations and sub-combinations thereof. Unless expressly excluded herein all such combinations and sub-combinations are intended to be within the scope of the present inventions.

Although several exemplary aspects of the present invention have been described herein, it should be appreciated that many modifications can be made without departing from the spirit and scope of the general inventive concepts. All such modifications are intended to be included within the scope of this invention and the related general inventive concepts.

1. A roofing shingle comprising:
an asphalt-coated sheet; and
a plurality of granules disposed on at least a portion of the asphalt-coated sheet, wherein the plurality of granules comprises from 1 wt. % to 7 wt. % of residual asphalt based on a total weight of the plurality of granules, wherein the granules are at least partially coated with the residual asphalt; and
wherein the roofing shingle has a granule scrub loss of less than 1.0 g as measured according to ASTM D4977.

2. The roofing shingle of claim 1, wherein the plurality of granules is disposed on a headlap portion of the asphalt-coated sheet.

3. The roofing shingle of claim 1, wherein the granule scrub loss according to ASTM D4977 is improved by greater than or equal to about 5% based on a loss of total mass compared to a loss of total mass of a comparable shingle not including the residual asphalt coating.

4. The roofing shingle of claim 1, wherein the roofing shingle has a granule scrub loss of less than 0.5 g as measured according to ASTM D4977.

5. The roofing shingle of claim 1, wherein the plurality of granules comprises from 1 wt. % to 5.5 wt. % of residual asphalt based on a total weight of the plurality of granules.

6. The roofing shingle of claim 1, wherein the plurality of granules is obtained from recycled asphalt shingles.

7. The roofing shingle of claim 1, wherein the plurality of granules is a first plurality of granules, the roofing shingle further comprising a second plurality of granules, wherein the second plurality of granules does not include a residual asphalt coating.

8. The roofing shingle of claim 1, wherein the asphalt coating comprises non-oxidized asphalt.

9. The roofing shingle of claim 1, wherein the asphalt coating comprises polymer modified asphalt.

10. The roofing shingle of claim 1, wherein the bond strength between roofing shingles according to a modified ASTM D6381M-15 (2020) is improved by greater than or equal to about 10% compared to a comparable shingle not including the residual asphalt coating.

11. A method of manufacturing a roofing shingle comprising:
applying an asphalt coating to at least one surface of a substrate, thereby forming an asphalt-coated sheet; and
depositing a plurality of recycled granules on the asphalt-coated sheet, the plurality of recycled granules having residual asphalt at least partially coated thereon, wherein the plurality of recycled granules was obtained from recycled asphalt shingles and the residual asphalt coating is present in an amount of 1 wt. % to 7 wt. %, based on a total weight of the plurality of recycled granules.

12. The method of claim 11, wherein the plurality of recycled granules is not subjected to a cleaning step or separation step prior to being deposited on the asphalt-coated sheet.

13. The method of claim 11, further comprising depositing on the asphalt-coated sheet a plurality of virgin granules.

14. The method of claim 11, wherein the roofing shingle has a granule scrub loss of less than 1.0 g as measured according to ASTM D4977.

15. The method of claim 11, wherein the granule scrub loss according to ASTM D4977 is improved by greater than or equal to about 5% based on a loss of total mass compared to a loss of total mass of a comparable shingle not including the residual asphalt coating.

16. The method of claim 11, wherein the plurality of recycled granules is deposited on a headlap portion of the roofing shingle.

17. A roofing product comprising:
an asphalt-coated sheet; and
a plurality of surfacing minerals disposed on at least a portion of the asphalt-coated sheet, wherein the plurality of surfacing minerals comprises from 1 wt. % to 7 wt. % of residual asphalt based on a total weight of the plurality of surfacing minerals, wherein the surfacing minerals are at least partially coated with the residual asphalt; and
wherein the roofing product has a surfacing mineral scrub loss of less than 1.0 g as measured according to ASTM D4977.

18. The roofing product of claim 17, wherein the surfacing mineral scrub loss according to ASTM D4977 is improved by greater than or equal to about 5% based on a loss of total mass compared to a loss of total mass of a comparable roofing product not including the residual asphalt coating.

19. The roofing product of claim 17, wherein the bond strength between adjacent layers of the roofing product according to a modified ASTM D6381M-15 (2020) is improved by greater than or equal to about 10% compared to a comparable roofing product not including the residual asphalt coating.

20. The roofing product of claim 17, wherein the plurality of surfacing minerals comprises sand.
